(19) United States
(12) Patent Application Publication
(10) Pub. No.: US 2025/0231851 A1
(43) Pub. Date: Jul. 17, 2025

(54) ISSUE DETECTION AND SOLUTION RESPONSE

(71) Applicant: ServiceNow, Inc., Santa Clara, CA (US)

(72) Inventors: Ganesh Parameshwar Bhat, Bangalore (IN); Gaurav Garg, Delhi (IN); Harsha Vijayakumar, Milpitas, CA (US); Cary Evans, Encinitas, CA (US); Shruti Jain, Jalgaon (IN)

(21) Appl. No.: 18/415,413

(22) Filed: Jan. 17, 2024

(51) Int. Cl. G06F 11/30

(52) U.S. Cl. CPC G06F 11/3072; G06F 11/3034; G06F 11/3037; G06F 11/3051

(57) ABSTRACT

A specification of a condition to trigger detection of a specific issue of an information technology component is received. Computer usage data is collected via one or more computer agents on one or more clients. A portion of the computer usage data that satisfies the condition of the specific issue is identified. A prompt based on the portion of the computer usage data is determined. Using a generative machine learning model, a solution to the specific issue based on the prompt is generated.

### BACKGROUND OF THE INVENTION

Organizations can require and deploy a large number of computing devices such as laptops, desktops, servers, and mobile devices. These deployments can include different hardware and software configurations as well as different deployment locations such as different geographic locations. An example software configuration can include the installation of a broad set of applications including desktop and Software-as-a-Service (SaaS) applications. These deployed devices and their corresponding users can require information technology support to maintain their proper working operation.

### BRIEF DESCRIPTION OF THE DRAWINGS

Various embodiments of the invention are disclosed in the following detailed description and the accompanying drawings.

FIG. 1 is a block diagram illustrating an embodiment of a platform for an issue resolution service.

FIG. 2 is a block diagram illustrating an embodiment of a client device configured for monitoring and receiving solutions for detected issues.

FIG. 3 is a block diagram illustrating an embodiment of an issue resolution service.

FIG. 4 is a flow chart illustrating an embodiment of a process for resolving issues impacting clients.

FIG. 5 is a flow chart illustrating an embodiment of a process for configuring a client for resolving issues impacting the client.

FIG. 6 is a flow chart illustrating an embodiment of a process for providing a solution to an issue detected from analyzing collected client data.

FIG. 7 is a flow chart illustrating an embodiment of a process for providing a validated solution to an issue detected from analyzing collected client data.

FIG. 8 is a flow chart illustrating an embodiment of a process for generating dynamically an issue solution.

FIG. 9 is a flow chart illustrating an embodiment of a process for generating dynamically an issue solution using received feedback.

FIG. 10 is a functional diagram illustrating a programmed computer system for resolving issues impacting clients.

FIG. 11 is a diagram illustrating an embodiment of a user interface for viewing a validated solution for an identified issue.

FIG. 12 is a diagram illustrating an embodiment of a user interface for creating a rule for automatically identifying an issue impacting a monitored client.

FIG. 13 is a diagram illustrating an embodiment of a user interface for defining conditions for a rule for automatically identifying an issue impacting a monitored client.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Issue detection and the determination of an appropriate solution response is disclosed. For example, a network of deployed devices such as laptops, desktops, servers, and mobile devices, among other devices is monitored for device metrics such as usage and operating metrics. The monitoring can be performed by a combination of monitoring components including a device agent, a menu or system tray application, and/or a web browser monitoring extension. The monitored data is provided to an issue resolution service that automates the identification of issues and determines an appropriate solution. In some embodiments, the issue resolution service enhances and aggregates the monitored data received from clients. Depending on the deployment scenario, the number of clients from which data is aggregated can include hundreds of thousands or more devices. The aggregated data is analyzed to automatically identify issues such as hardware crashes, equipment failure, application errors, etc. In some embodiments, the detected issues can be configured using one or more rules that when the proper conditions are met, triggers the identification of an issue. The rules can be configured, for example, based on location, application and/or hardware device, user department, user group, usage metric, instance count, volume count, repetition count, interval time, etc. In various embodiments, the configured rules and their conditions allow issues to be identified using aggregated metrics such as when a certain percentage of devices in a certain region experiences a certain event, such as a page load time greater than 1,000 milliseconds.

In various embodiments, once an issue is detected, a resolution or solution for the issue is determined. The solution can be determined by searching a known solution repository for existing validated solutions. In the event a known and validated stored solution is not found, a solution can be generated dynamically using generative artificial intelligence (AI) techniques. For example, a generative AI prompt is created using the monitored data and the information related to the detected issue to determine the appropriate solution response. The generated prompt for determining the issue solution is evaluated using one or more generative AI models such as one or more large language models. An applied large language model can be trained with external data sources such as application and hardware manuals, knowledge repositories, FAQs, vendor databases, etc. In some embodiments, the evaluation of the prompt using a selected large language model has access to live data sources such as the Internet and/or other repositories that are continuously updated. In some embodiments, a variety of large language models are available for use and the appropriate ones are selected, for example, based on the issue and/or the results. Once the results of an applied large language model are provided, the solution result can be validated for accuracy. In some embodiments, the solution is validated by requiring an operator or another user (such as a human user) to review the proposed solution. Alternatively, the solution validation can be automated, for example, by comparing the solution to other generated solutions and/or known solutions. In various embodiments, once validated, the determined solution can be provided and/or deployed to the appropriate clients including proactively in advance of an expected issue and/or in response to experiencing an issue. For example, a tray application can be provided with the steps for resolving the issue and/or a patch can be automatically deployed for installation at a targeted computing device using an installed device agent for deployment and installation of an issue solution patch.

In some embodiments, a specification of a condition to trigger detection of a specific issue of an information technology component is received. For example, a condition can be created to trigger the detection of issues for monitored devices within an information technology environment. The condition can be specified as a rule and the rule configured, for example, based on location (such as a geographic and/or network location), application (such as by application name) and/or hardware device, user department, user group, usage metric, instance count, volume count, repetition count, interval time, and/or other device related parameters. In some embodiments, an indication that a solution to the specific issue characterized by the condition is to be generated dynamically using a generative machine learning model is received. For example, the solution for the specific issue can be a known and validated solution stored for retrieval, for example, in a knowledge repository. In some scenarios, a known and/or validated solution does not exist and an indication, such as a configured issue parameter, is utilized to specify that a solution should be dynamically generated using one or more generative machine learning models. In some embodiments, computer usage data is collected via one or more computer agents on one or more devices. For example, devices can be monitored for their usage data via agents such as installed monitoring agents. In some embodiments, a monitoring agent installed on a device is integrated with a menu (or system tray) application and/or a web browser extension to improve the collection of computer usage data. The collected usage data can include device data such as device configuration data as well as operating data including application performance metrics, crash reports, and/or logs, among other usage data.

In some embodiments, a portion of the computer usage data that satisfies the condition of the specific issue is identified. For example, the collected usage data can be analyzed, for example, by an issue resolution service, to detect issues described by specified conditions. In various embodiments, a determination is made that the condition of the specific issue is met based on the collected computer usage data. The collected usage data can be aggregated, and the issues can be detected by analyzing aggregated usage data. As part of the analysis, the portion of the computer usage data that satisfies the condition of the specific issue is identified. In some embodiments, a prompt based on the portion of the computer usage data is determined. For example, at least a portion of the collected computer usage data is included in a generated prompt provided to a generative machine learning model. In various embodiments, when a known and validated solution does not exist, a generative artificial intelligence (AI) prompt is created using at least a portion of the collected computer usage data. Other data included in the prompt can include information related to the detected issue and/or similar issues and their solutions. In some embodiments, using a generative machine learning model, a solution to the specific issue based on the prompt is generated. For example, a solution is generated for the specific issues using a version of a result of the generative machine learning model. The solution can be automatically provided as the solution to the specific issue. For example, the generated prompt is evaluated using a generative machine learning model such as a large language model to provide a solution to the detected issue. The solution or a version of the solution provided by the generative machine learning model can be provided to the devices impacted by the detected issue. In some embodiments, the solution is first validated, and a version of the validated solution is automatically provided to impacted devices. For example, a solution can include a description of the steps to perform to resolve the detected issue and the solution is automatically provided to impacted devices via a menu application installed of the impacted devices. In some embodiments, a patch can be automatically deployed to impacted devices such as via the installed monitoring agent.

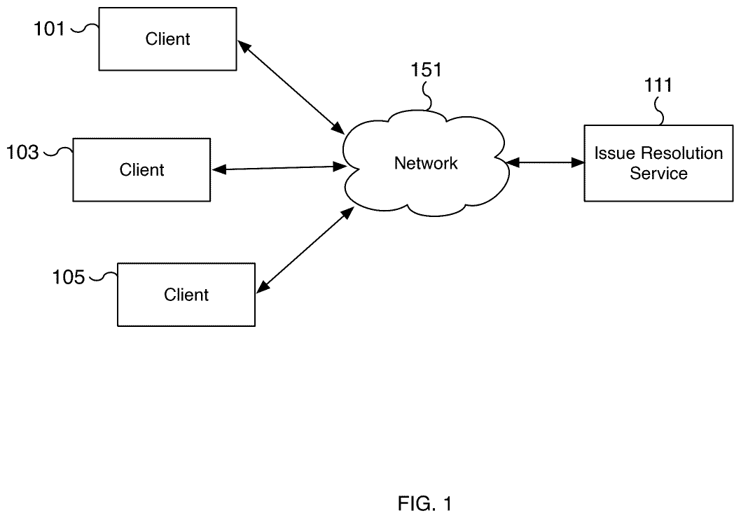

FIG. 1 is a block diagram illustrating an embodiment of a platform for an issue resolution service. In the example shown, clients 101, 103, and 105 are network clients configured for monitoring. The monitoring can be performed by an installed agent, a menu or system tray application, and/or a web browser monitoring extension. Clients 101, 103, and 105 are communicatively connected to issue resolution service 111 via network 151. Network 151 can be a public or private network. In some embodiments, network 151 is a public network such as the Internet. Issue resolution service 111 provides a cloud-based service to automatically identify issues among monitored devices such as clients 101, 103, and 105 and to determine and provide solutions to resolve the detected issues. Issue resolution service 111 can also provide a user interface, such as an interactive user interface dashboard for configuring issues for identification and resolution and/or for reviewing and/or managing issue solutions, among other management aspects of issue resolution.

In some embodiments, clients 101, 103, and 105 are each a network client device for running applications such as desktop applications and cloud or web-based applications including Software-as-a-Service (SaaS) applications. Each of clients 101, 103, and 105 is configured with a monitoring agent (not shown) that collects and provides device data including usage data of applications to issue resolution service 111. For example, a communication channel can be established between issue resolution service 111 and each of clients 101, 103, and 105 to provide collected client data. In some embodiments, the communication channel is established between issue resolution service 111 and the corresponding monitoring agent installed on each of clients 101, 103, and 105. In some embodiments, the installed monitoring agent is integrated with additional components (not shown), such as a menu or system tray application and/or a web browser monitoring extension, to improve the collection of client data including usage data.

In some embodiments, each of clients 101, 103, and 105 can be configured with a menu or system tray application for monitoring applications such as desktop, native, or local applications executed on a client device. The menu or system tray application can be part of an installed monitoring agent or function as a separate application that communicates with the monitoring agent. In various embodiments, the installed menu or system tray application can provide a graphical user interface for monitoring services including issue resolution services. For example, the menu or system tray application can receive and display solutions provided by issue resolution service 111 for detected issues. In various embodiments, data collected by the menu or system tray application is provided to the installed monitoring agent of the same client device. The monitoring agent then provides collected usage data to issue resolution service 111. In some embodiments, the monitoring agent is implemented as a stand-alone application such as an agent daemon or service running on a client device and the agent communicates with the menu or system tray application to collect and forward usage data to issue resolution service 111. Although described as a monitoring agent, in various embodiments, the actual implementation of the agent can be as a multipurpose monitoring agent with the ability to monitor device health including application health among other metrics, activities, features, functionality, capabilities, data, etc.

In some embodiments, each of clients 101, 103, and 105 can be configured with a browser extension or plug-in (not shown) for monitoring web-based applications accessed via a web browser. The configured browser extension can monitor and collect usage data associated with applications accessed via the associated web browser. For example, SaaS application usage data can be collected by the browser extension when an SaaS application is accessed via the associated web browser. In various embodiments, the collected usage data is provided by the browser extension to the installed monitoring agent of the same client device. The monitoring agent then provides collected usage data to issue resolution service 111. In some embodiments, the monitoring agent is implemented as a browser extension. In some embodiments, the monitoring agent is implemented as a stand-alone application such as an agent daemon or service running on a client device and the agent communicates with the browser extension to collect and forward browser-based application usage data to issue resolution service 111.

In some embodiments, the services provided by issue resolution service 111 are accessed by users of network clients such as clients 101, 103, and 105. For example, an IT administrator via network clients such as clients 101, 103, and 105 can configure clients for monitoring and the issues to detect based on the data collected from monitoring configured clients. As another example, an IT administrator via network clients such as clients 101, 103, and 105 can access a dashboard or similar user interface provided by issue resolution service 111 to manage the issues configured for detection and their validated solutions. In some embodiments, the dashboard is accessed via a web browser and the interactive user interface dashboard is provided at least in part by issue resolution service 111. In some embodiments, the dashboard is accessible via a custom application provided by issue resolution service 111. For example, a custom application can include a menu or system tray application, a chat bot application, and/or a cloud-based desktop application, among others for interacting with issue resolution service 111.

In some embodiments, issue resolution service 111 is a cloud service that offers issues detection and provides solutions for detected issues as a cloud service. The provided issue resolution services can include the ability to configure and manage the monitoring of clients such as clients 101, 103, and 105, the ability to configure issues for detection based on at least in part on the data collected from monitoring clients, the ability to dynamically generate solutions for detected issues, and the ability to provide a validated solution to impacted clients for detected issues. For example, issue resolution service 111 can collect usage data from clients 101, 103, and 105. The data can be aggregated and analyzed to determine if a condition is met to trigger the identification of an issue. Once an issue is identified, a known validated solution can be retrieved and provided to impacted clients, and/or a solution can be generated dynamically using a generative machine learning model, the generated solution validated, and then a version of the validated solution provided to impacted clients.

Although single instances of some components have been shown to simplify the diagram of FIG. 1, additional instances of any of the components shown in FIG. 1 may exist. For example, issue resolution service 111 may include one or more cloud servers and one or more databases utilized by the cloud servers. Additionally, clients 101, 103, and 105 are example client devices for client monitoring and/or the administration of monitoring and issue resolution. In some scenarios, each of clients 101, 103, and 105 may only function as a client for monitoring and the automated resolution of issues or as a client for the administration of monitoring and the automated resolution of issues (via issue resolution service 111) but not both. Although three clients are shown (clients 101, 103, and 105), many more additional clients can exist and communicate with and/or be managed from issue resolution service 111. For example, in some deployment scenarios, the number of clients can exceed hundreds of thousands of clients. In some embodiments, components not shown in FIG. 1 may also exist.

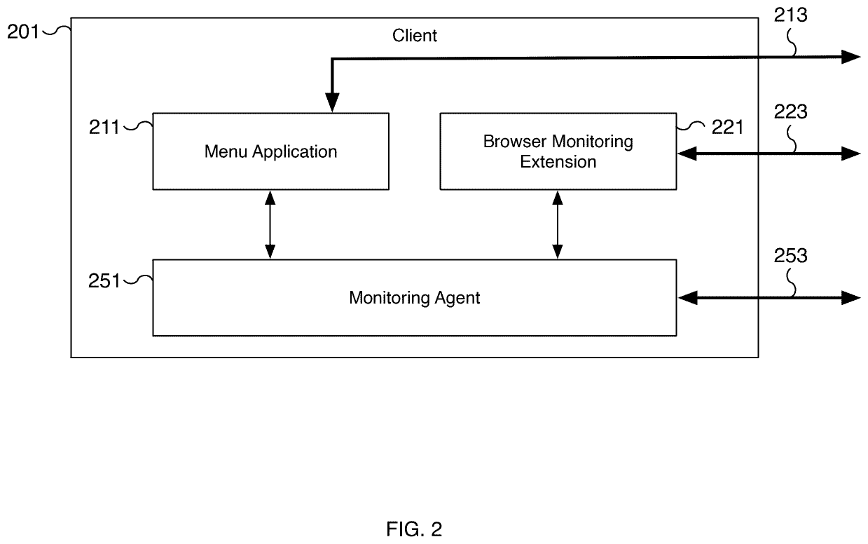

FIG. 2 is a block diagram illustrating an embodiment of a client device configured for monitoring and receiving solutions for detected issues. In the example shown, client 201 is a network client and includes menu application 211, browser monitoring extension 221, and monitoring agent 251. In various embodiments, menu application 211, browser monitoring extension 221, and monitoring agent 251 can establish network connections 213, 223, and 253, respectively. In some embodiments, monitoring agent 251 is an application such as an operating system application and is configured as an agent for monitoring client 201 and for receiving solutions from an issue resolution service for issues identified as relevant to client 201. Monitoring agent 251 further interfaces with menu application 211 and browser monitoring extension 221. In some embodiments, menu application 211 is a menu (or similar type of) application for performing issue related tasks for client 201, such as displaying and/or managing a provided solution to a detected issue. In some embodiments, menu application 211 may also gather data of client 201 and provide the collected data to monitoring agent 251. In some embodiments, browser monitoring extension 221 is an extension to and integrated with a web browser (not shown) of client 201. Browser monitoring extension 221 can be utilized for capturing browser related data including browser-related usage data. The data captured by menu application 211 and/or browser monitoring extension 221 can be provided to monitoring agent 251, which in turn provides the data to an issue resolution service for the detection of issues impacting client 201 and/or related clients (not shown). In various embodiments, solutions for detected issues are received at client 201 at menu application 211, browser monitoring extension 221, and/or monitoring agent 251 via network connections 213, 223, and/or 253, respectively. In some embodiments, the cloud-based issue resolution service is issue resolution service 111 of FIG. 1 and client 201 is client 101, 103, and/or 105 of FIG. 1.

In some embodiments, client 201 is a network client such as a desktop computer, a laptop, a mobile device, a tablet, a kiosk, a voice assistant, a wearable device, or another network computing device. Client 201 may be managed by an IT operations group and can be configured for accessing applications including applications approved by the IT operations group. Users of client 201 may execute and run applications using client 201 including local applications and/or web-based applications. For example, applications utilized by users of client 201 can include applications installed on client 201 as well as applications accessed via a browser associated with browser monitoring extension 221. Client 201 is configured for monitoring by installing on client 201 monitoring agent 251, menu application 211, and/or browser monitoring extension 221. In some embodiments, client 201 can be configured for monitoring, issue detection, and/or issue resolution via monitoring agent 251 and network connection 253.

In some embodiments, monitoring agent 251 is an agent application installed on client 201. Monitoring agent 251 can be configured for monitoring applications, for communicating with menu application 211 and browser monitoring extension 221, and for receiving and deploying solutions for detected issues, among other tasks. In various embodiments, monitoring agent 251 is configured to communicate with a cloud-based issue resolution service via network connection 253. In the example shown, monitoring agent 251 monitors and collects data associated with client 201 and the applications accessed by client 201 including both local applications and browser-based applications. For example, monitoring agent 251 can be configured to collect usage data related to network transfers including incoming and/or outgoing network bytes, CPU usage, memory usage, crashes, error events, restarts, application configurations including versions, applications installed and/or running, application updates, usage including usage based on particular metrics such as by day, version, user, etc., and/or access data including last access time and total access time, among other usage and operations metrics. In some embodiments, monitoring agent 251 collects client metrics related to application usage include metrics related to CPU usage (such as processor activity and/or processor performance), memory usage, uptime, system time, disk or storage input/output usage, antivirus functionality, operating system errors and counts, battery health, disk or storage capacity, pending updates, application crashes, and/or triggering events such as software, network, and/or hardware events, among other usage and operations metrics. Additionally, monitoring agent 251 can receive data collected by menu application 211 and/or browser monitoring extension 221. For example, based on access permissions and/or restrictions, menu application 211 and/or browser monitoring extension 221 may be configured to access and collect client data that is not directly accessible by monitoring agent 251.

In some embodiments, monitoring agent 251 provides collected client data to an issue resolution service via network connection 253. In return, the issue resolution service provides solutions to identified issues relevant to client 201. For example, when an issue is detected and a solution for the issue is determined, the determined solution is provided to monitoring agent 251 of client 201 via network connection 253. In some embodiments, monitoring agent 251 deploys the received solution, such as a patch or upgrade, to resolve the detected issue. In some embodiments, monitoring agent 251 provides the solution to menu application 211 and/or browser monitoring extension 221. For example, menu application 211 and/or browser monitoring extension 221 can function as a user interface for displaying and managing solutions to identified issues.

In some embodiments, menu application 211 is a menu application for performing issue related tasks for client 201, such as displaying and/or managing a provided solution to a detected issue. For example, a solution for an issue provided by an issue resolution service can be provided to menu application 211, and menu application 211 can function as a user interface for displaying and managing the solution including notifications related to the solution. In some embodiments, the solution is provided first to monitoring agent 251, such as via network connection 253, and then to menu application 211. In some embodiments, the solution is provided directly to menu application 211, such as via network connection 213. In some embodiments, menu application 211 can further perform monitoring activities such as monitoring user and/or device data of client 201. The collected data can be provided by menu application 211 to monitoring agent 251 to forward to an issue resolution service. Although described as a menu application, in some embodiments, menu application 211 is implemented as a system tray application, a widget application, dashboard application, and/or as another similar application. Further, while described herein with respect to the disclosed issue resolution features, in various embodiments, menu application 211 may include additional features such as the ability to access and install applications, the ability to access one or more knowledge repositories including via a chat bot or another interface, the ability to receive and manage notifications, the ability to submit tickets and/or reports including incident reports, among other features. In some embodiments, menu application 211 is configured via monitoring agent 251, one or more network connections such as network connections 213 and/or 253, and/or via another remote configuration interface.

In some embodiments, browser monitoring extension 221 is an extension and/or plug-in integrated into a browser application (not shown) of client 201 for monitoring browser-related client data. In some embodiments, network connection 223 is utilized by an associated browser application (not shown) to access browser-based applications such as cloud or web-based applications including Software-as-a-Service (SaaS) applications, and browser monitoring extension 221 can monitor and collect data related to the associated browser and/or network connection 223. For example, browser monitoring extension 221 can collect data related to the performance of browser-based applications such as response times, load times, data utilized, network endpoints, etc. In some embodiments, unlike monitoring agent 251 and/or menu application 211, browser monitoring extension 221 is configured with permissions that allow for the collection and monitoring of usage data specific and/or local to a browser of client 201. For example, usage data associated with accessing an SaaS application can be collected by browser monitoring extension 221. In various embodiments, usage data collected by browser monitoring extension 221 can include data related to application availability, response time, usage time including total usage time, DNS lookup time, failed request data, total session time, page views, load times including page load times, response times, and access times including last access time, among other usage and operations data. In some embodiments, browser monitoring extension 221 is configured with a list of web applications to monitor, such as via a list of web sites, domains, and/or application names, and only the configured applications have their associated usage data collected. In various embodiments, the data collected by browser monitoring extension 221 is provided to monitoring agent 251, for example, as a means of providing the collected browser-based usage data to an issue resolution service. In some embodiments, browser monitoring extension 221 is configured via monitoring agent 251, one or more network connections such as network connections 223 and/or 253, and/or via another remote configuration interface.

In some embodiments, when an issue is detected and a corresponding solution for the issue is determined, for example, by a cloud-based issue resolution service, the determined solution is provided to client 201 via network connections 213, 223, and/or 253. For example, a solution can be provided to monitoring agent 251 via network connection 253 and then forwarded to menu application 211 and/or browser monitoring extension 221. In some embodiments, the solution is provided directly to menu application 211 and/or browser monitoring extension 221 via network connections 213 and 223, respectively. Once a solution is provided to client 201, the solution can be applied, for example, in the event the solution is a patch or similar executable program such as a software or firmware update for resolving the issue. In the event the solution is a document such as a written description or video describing the steps for resolving an issue, the solution can be presented to the user of client 201 via menu application 211 and/or a browser associated with browser monitoring extension 221. For example, a user can access provided solutions via a graphical user interface of menu application 211. In some embodiments, menu application 211 can also provide notifications of detected issues and their corresponding solutions and provide a means for accessing and/or applying a referenced solution to a detected issue.

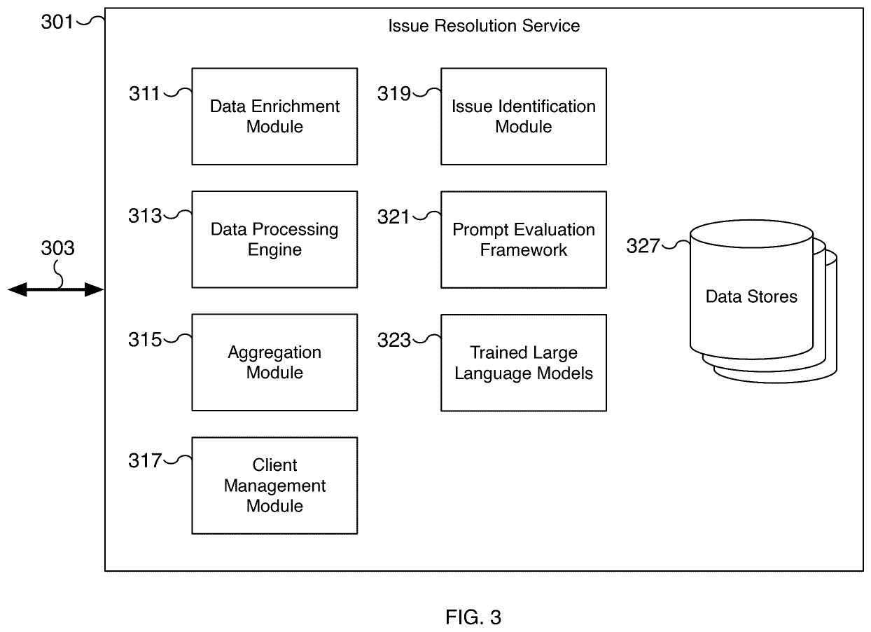

FIG. 3 is a block diagram illustrating an embodiment of an issue resolution service. In the example shown, issue resolution service 301 is a cloud-based service for detecting issues impacted by remote clients and providing solutions for the identified issues. Issue resolution service 301 communicates with remote clients via network connection 303 and includes multiple processing modules including data enrichment module 311, data processing engine 313, aggregation module 315, client management module 317, issue identification module 319, prompt evaluation framework 321, and trained large language models 323. In various embodiments, issue resolution service 301 utilizes one or more data stores such as data stores 327. In some embodiments, issue resolution service 301 is issue resolution service 111 of FIG. 1. In some embodiments, the clients monitored and managed by issue resolution service 301 include client 101, 103, and/or 105 of FIG. 1 and/or client 201 of FIG. 2.

In some embodiments, issue resolution service 301 includes multiple processing modules for performing one or more different tasks associated with issue resolution including the collection and analysis of data collected from remote clients to identify issues and the determination of validated solutions for identified issues. In various embodiments, one or more of the modules shown may not exist and/or additional modules may exist. In some embodiments, the functionality of one or more of the modules may be merged into a single module or split out across multiple different modules. In the example shown, issue resolution service 301 receives client data from remote clients via network connection 303 and utilizes network connection 303 to provide solutions to remote clients. For example, a communication channel is established via network connection 303 with a client to receive usage data collected for the client. The client's data is aggregated with data from other clients and analyzed. Solutions for issues identified from the analysis are determined and provided to clients. In the event an existing validated solution does not exist, a solution can be generated dynamically using a generative machine learning model and validated. In various embodiments, the communication channel established via network connection 303 with a client can be used to provide a validated solution for an issue identified as relevant to the client. In some embodiments, the communication channel established via network connection 303 is further used to configure monitoring and data collection for the client, including which applications to collect data for and the type of data to collect.

In some embodiments, data enrichment module 311 is utilized to enrich the incoming client data. For example, data enrichment module 311 can be used to augment, annotate, and/or add additional detail to client data including usage data collected from the client. In some embodiments, data enrichment module 311 functions to provide location data for the client including network connection data such as a network address and/or geographical data such as the city, sub-region, region, state, and/or locale of the client. In some embodiments, data enrichment module 311 includes additional enrichment functionality such as identifying the geographic location of a client by parameters of the client such as the client's IP address. Other data enrichment can include adding time stamps associated with collected data and calculating latency and throughput metrics for the client connection. In various embodiments, the data enrichment performed by data enrichment module 311 can be based on an identifier of the client such as the client's IP address. Additional metadata not available at the client can be retrieved and/or determined and used to enrich the collected usage data. For example, hardware, firmware, and/or software configurations can be retrieved for the client and used to enrich the collected client data. In some embodiments, the enriched data is based on aggregated information from multiple clients. For example, the collected data can be enriched based on collected data from across different clients of the same or different region (or sub-region). In various embodiments, once the data is enriched, the enriched data is provided to data processing engine 313.

In some embodiments, data processing engine 313 is used to process the incoming client data including the data enriched by data enrichment module 311. In various embodiments, data processing engine 313 is a streaming engine and can process a continuous stream of input data in real time. For example, data processing engine 313 can utilize a high throughput performance bus for receiving and processing usage data from multiple clients. In various embodiments, the data is processed and written to one or more data stores such as data stores 327. In some embodiments, the processing includes providing the client data as raw time-series data and/or rolled-up data. For example, rolled-up usage data can be provided by data processing engine 313 by merging usage data across multiple clients and trimming the merged data to emphasize the most relevant metrics. In some embodiments, the processing performed by data processing engine 313 utilizes additional processing modules such as aggregation module 315.

In some embodiments, aggregation module 315 is a processing module for aggregating client data across multiple clients. For example, for a particular application and/or application version, client usage data can be analyzed to provide aggregated usage results such as the average application uptime for an application, the average number of crashes for an application, and the typical usage time for an application, etc. In various embodiments, the data is aggregated over one or more different windows of time, such as per minute, per day, per week, per month, or another interval of granularity. In some embodiments, the data is aggregated based on geography such as by region, by sub-region, by network location, etc. Other forms of aggregation can be performed as well, such as by user groups, usage metrics, departments, operating system version, application version, etc.

In some embodiments, client management module 317 is a processing module for configuring clients for issue resolution. For example, using client management module 317, issue resolution service 301 can provide a user interface for managing issues encountered by remote clients including the management of client monitoring and the deployment of solutions for identified issues. In some embodiments, the configuration settings for client monitoring and issue resolution are stored by client management module 317 on one or more data stores of data stores 327. For example, each client can be configured with an inclusion list of applications to monitor, the metrics to collect for the monitored application, issues encountered, solutions provided for encountered issues, and the resolution status of encountered issues.

In some embodiments, issue identification module 319 is a processing module for identifying issues impacting monitored clients and providing a validated solution for identified issues. For example, issue identification module 319 can analyze the client data including the aggregated client data to identify issues relevant to a client without the client submitting an incident ticket. For example, based on data collected from monitored clients, such as lagging performance metrics for a web service utilized by clients, issue identification module 319 can identify an issue with the specific web service that impacts or will impact a certain set of clients, such as clients in a particular region. Once an issue is identified, issue identification module 319 will determine a validated solution. In some scenarios, a known and validated solution exists and can be retrieved from a known solution repository, and issue identification module 319 can provide the retrieved validated solution to impacted clients. In the event a validated solution does not exist, issue identification module 319 can initiate the dynamic generation of a solution using generative artificial technology (AI) techniques. For example, issue identification module 319 can utilize prompt evaluation framework 321 and trained large language models 323 to generate a solution for the identified issue using a generative machine learning model. In some embodiments, the solution results generated by prompt evaluation framework 321 and trained large language models 323 are validated before they are provided to clients. For example, once a solution is validated, whether by a human administrator and/or via an automated process, the validated solution is provided to impacted clients to resolve the identified issue. In some embodiments, a validated solution that is dynamically generated can be stored for future use in the event the issue is encountered again. In various embodiments, the known solution repository utilized by issue identification module 319 is stored in data stores 327.

In some embodiments, prompt evaluation framework 321 is a framework for generating and applying prompts using a generative machine learning model. For example, prompt evaluation framework 321 can be used to generate a prompt to dynamically generate a solution for an identified issue impacting one or more clients. The generated prompt can be applied to a generative machine learning model such as one or more large language models of trained large language models 323, and the corresponding results can be received and processed. In some embodiments, the process is an interactive process that includes a series of prompts and corresponding results allowing the results to be refined and validated as an iterative process. In various embodiments, prompt evaluation framework 321 may perform preprocessing steps such as preprocessing the input data such as creating generative artificial intelligence (AI) prompts that include the preprocessed input data that can be understood by a trained large language model of trained large language models 323. The processing can include tokenization and encoding the provided input data among other actions. Similarly, prompt evaluation framework 321 can postprocess the output of a trained large language model of trained large language models 323, for example, to make the results conform with the format of a validated solution.

In some embodiments, trained large language models 323 is a set of one or more pre-trained large language models. The models of trained large language models 323 can be trained using significantly large amounts of data and are enabled to process language, including human and/or natural language, as well as crash reports, application logs, network activity, and/or other client data from collected metrics to provide a result in response to provided prompts. In various embodiments, trained large language models 323 is trained with and/or can be supplemented with knowledge from external data sources such as the Internet, customer databases, application knowledge bases, etc. In various embodiments, trained large language models 323 can include third-party large language models such as a large language model trained by a third-party for performing both specific and generic artificial intelligence (AI) tasks. For example, a third-party model can be accessed via a generative AI model application programming interface (API) and trained large language models 323 can provide an interface to available generative AI APIs to access for both local and third-party models. In some embodiments, by using a generative AI model API, a remotely hosted and/or a third-party model can be utilized to dynamically generate a solution. In some embodiments, the training performed on trained large language models 323 includes training related to information technology issues and their solutions. In some embodiments, local trained models are stored in data stores 327.

In some embodiments, issue resolution service 301 stores the collected client data including the enriched, processed, aggregated, and/or analyzed data and corresponding results in one or more data stores of data stores 327. In some embodiments, data stores 327 are remote databases and can include one or more distributed databases and/or one or more time series databases. In various embodiments, issue resolution service 301 further stores configuration and management settings for clients in data stores 327. In some embodiments, issue resolution service 301 stores known and validated solutions to issues in data stores 327.

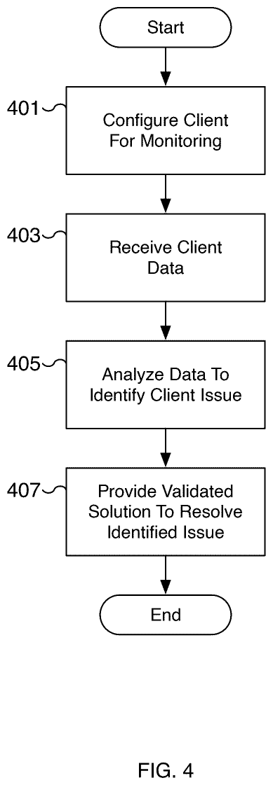

FIG. 4 is a flow chart illustrating an embodiment of a process for resolving issues impacting clients. For example, using the process of FIG. 4, one or more clients can be configured to identify and resolve issues relevant to impacted clients using an issue resolution service. In some embodiments, the issue resolution service is used to configure the clients including which applications to monitor and what data to collect. As data is collected at the client and provided to the issue resolution service, the issue resolution service can analyze the provided data including performing data enrichment and aggregation to identify issues impacting the client or other related clients. In response to identifying an issue, a validated solution is determined and provided to impacted clients. In some embodiments, the issue resolution service is issue resolution service 111 of FIG. 1 and/or issue resolution service 301 of FIG. 3. In some embodiments, the client device is client 101, 103, and/or 105 of FIG. 1 and/or client 201 of FIG. 2.

At 401, a client is configured for monitoring. In some embodiments, the client including its usage and operating performance is configured for monitoring. In some embodiments, a list of applications to monitor, such as via a list of application names, web sites, and/or domains, is provided by an IT administrator and the configured applications have their associated usage data collected. For example, an IT administrator can configure an inclusion list of applications for which to collect usage data from and the types of usage data to collect. Examples of data configured for collection can include data related to application availability, response time, usage time including total usage time, DNS lookup time, failed request data, total session time, page views, load times including page load times, response times, and access times including the last access time, among other usage and operations data. In some embodiments, data collected for an installed application (as compared to browser-based applications) can further include usage data related to network transfers including incoming and/or outgoing network bytes, CPU usage, memory usage, crashes, error events, restarts, application configurations including versions, applications installed and/or running, application updates, usage including usage based on particular metrics such as by day, version, user, etc., and/or access data including last access time and total access time, among other usage and operations metrics.

In various embodiments, the configuration parameters are provided to the client via an agent, a menu application, and/or a browser extension installed on the client which performs the application monitoring and data collection. In some embodiments, the agent is monitoring agent 251 of FIG. 2, the menu application is menu application 211 of FIG. 2, and the browser extension is browser monitoring extension 221 of FIG. 2. For example, once the configuration is provided by an administrator to the issue resolution service, the issue resolution service can provide the client configuration to the appropriate client via a network channel established with the monitoring agent installed on the client device. In some embodiments, the monitoring agent then communicates with the browser monitoring extension to configure the browser extension for monitoring browser-based applications.

At 403, client data is received. For example, client data including application usage data collected at the client is received. In some embodiments, the data is streamed to the issue resolution service via a monitoring agent installed on the client. The received streamed data can correspond to data from multiple clients and can be processed via a high throughput performance bus for receiving and processing usage data from multiple clients.

At 405, the received data is analyzed to identify a client issue. For example, the data received at 403 is analyzed to identify issues impacting the client. The analysis of the data can include enriching the data with additional information based on the client and/or collection process. In some embodiments, the received data is analyzed by aggregating the data collected across multiple clients including by aggregating the data based on categories such as different time periods, user groups, locations or regions, availability, etc. In various embodiments, the analysis of the data identifies an issue impacting the client, such as an application crash or the degradation in performance for an application. The identified issue can be related to an issue experienced by the client (such as an application crash) and/or related to an issue that the client is expected to experience, such as degraded performance the next time the client accesses a specific web-based application.

At 407, a validated solution is provided to resolve the identified issue. For example, a validated solution that will resolve the issue is identified and provided to the client. The validated solution can be a known existing solution that has met approval requirements for use at clients. For example, a known solutions repository can be searched for a validated solution to the identified issue. In the event a known and validated solution exists, the validated solution can be retrieved from the known solutions repository and provided to the client. For example, the solution can be provided to an agent of the client and accessed via a menu application of the client. In the event no known and validated solution exists, a solution can be generated dynamically using a generative machine learning model and/or generative artificial intelligence (AI) techniques. For example, a trained large language model can be utilized with a generated generative AI prompt to determine a solution for the identified issue. In some embodiments, the results from using generative AI techniques are first validated, for example, either by an administrator or via an automated technique, and then provided to the client. In various embodiments, once a dynamically generated solution is validated, it can be stored in a known solutions repository and used for future instances of the issue without requiring the solution be regenerated.

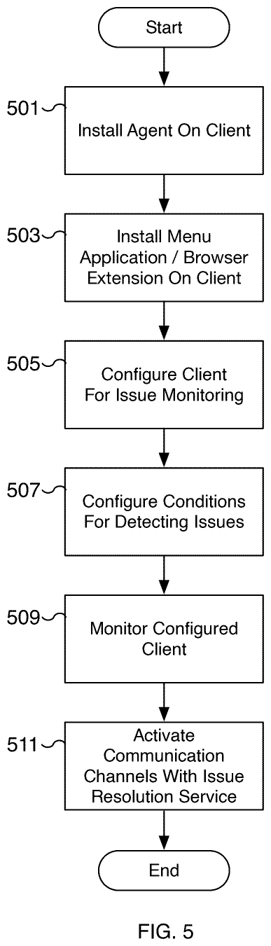

FIG. 5 is a flow chart illustrating an embodiment of a process for configuring a client for resolving issues impacting the client. For example, using the process of FIG. 5, one or more clients can be configured for issue resolution via an issue resolution service. Issues can be identified and a solution provided to resolve the issue without requiring a user operating the monitored client to submit an incident report. In some embodiments, the issue resolution service is used to configure the client including initiating the installation of a monitoring agent, menu application, and/or browser monitoring extension on the client to collect client data and to receive solutions for identified issues impacting the client. In some embodiments, the process of FIG. 5 is performed at 401 and/or 403 of FIG. 4. In some embodiments, the issue resolution service is issue resolution service 111 of FIG. 1 and/or issue resolution service 301 of FIG. 3. In some embodiments, the client device is client 101, 103, and/or 105 of FIG. 1 and/or client 201 of FIG. 2.

At 501, a monitoring agent is installed on the client. For example, a software monitoring agent is installed on the client with access privileges that allow the agent to monitor applications that are running on the client, monitor client device information including lower-level functionality such as operating system level and/or hardware functionality, and/or to receive solutions for identified issues. The agent can be further configured with access privileges to establish and/or accept a network connection between the agent on the client and the cloud-based issue resolution service. For example, the installed agent can collect client and application usage metrics and provide them via a network connection to a cloud-based issue resolution service. When an issue is identified by the cloud-based issue resolution service that impacts the client, the agent can receive a solution for the identified issue from the cloud-based issue resolution solution. In some embodiments, the installed agent communicates with one or more menu applications and/or browser monitoring extensions to relay additional data collected by the menu application and/or browser extensions to the cloud-based issue resolution service. The installed agent can also be utilized for updating the monitoring configuration parameters including the configuration of installed menu applications and/or browser monitoring extensions. In some embodiments, the monitoring agent is monitoring agent 251 of FIG. 2.

At 503, a menu application and/or browser monitoring extension is installed on the client. For example, a menu application is installed on the client that functions to monitor the client and/or provide a user interface for the monitoring agent and/or issue resolution service. In some embodiments, the menu application is a system tray application and/or another similar application. The menu application is configured to communicate with the client agent installed at 501, for example, to receive solutions for identified issues, receive configuration updates, and/or to relay collected usage data. For example, when a solution is provided to the client to address an identified issue, the solution can be accessed, displayed, reviewed, and/or applied via the menu application. In some embodiments, the menu application is menu application 211 of FIG. 2.

In various embodiments, a browser monitoring extension (or browser plug-in) is also installed on the client at 503. The installed browser monitoring extension is integrated with the client's browser software and is configured to allow the browser monitoring extension to monitor browser-based applications that are accessed via the client's web browser. For example, the browser monitoring extension can monitor the web sites and/or web applications that are accessed via the browser from the client and collect usage metrics such as response time, session time, page views, and page load time, among other metrics. In some embodiments, one or more different browser monitoring extensions are installed for each different browser configured for the client. For example, a different instance or version of a browser monitoring extension can be installed and/or customized for different web browsers. In some embodiments, the installed browser monitoring extension communicates with the client agent installed at 501, for example, to receive configuration updates and/or to relay collected usage data. In some embodiments, the browser monitoring extension is browser monitoring extension 221 of FIG. 2.

At 505, the client is configured for issue monitoring. For example, a list of metrics to monitor and collect usage data for are provided, for example, by an IT administrator. The list can include a list of applications and can specify whether an application is an installed application that is executed natively on the client or a web-based or Software-as-a-Service (SaaS) application that is accessed via the client browser. In various embodiments, the configured applications can be specified by application name, web site, domain name, domain wildcards, or another identification format. In some embodiments, the applications monitored are based on an inclusion list and an application must be added to the inclusion list in order for its usage to be monitored. In some embodiments, a different or default configuration for application monitoring is utilized. For example, default application monitoring settings can be configured during a provisioning step of the client. In various embodiments, the process of configuring a client for monitoring can include identifying what usage data and metrics are collected and how they are collected (e.g., parameters related to collection such as frequency, resolution, format, etc.). For example, an IT administrator can specify the metrics and data to collect as well as the frequency to collect the data. In some embodiments, the configuration parameters are provided and/or managed by an administrator via a cloud-based issue resolution service and then relayed to the installed agent, menu application, and/or browser extension. For example, the agent installed at 501 can receive the configuration parameters, update the configuration of the agent, and further provide menu application and browser-based configuration parameters to the installed menu application and browser monitoring extension, respectively. Upon receipt of their respective configuration updates, the menu application and the browser monitoring extension can each update their own configuration parameters.

At 507, conditions for detecting issues are configured. For example, an operator configures one or more rules that define one or more conditions required for detecting issues among the monitored clients. Each configured rule can describe a condition that when met, triggers the detection of an issue for impacted clients. In various embodiments, the rules and conditions are based at least in part on the data collected when monitoring clients. For example, a condition can be created based on location (such as a geographic and/or network location), application (such as by application name or description including application version number), device hardware configuration, user department, user group, usage metric, instance count, volume count, repetition count, interval time, and/or other device and/or client related parameters. Moreover, the utilized data and related metrics can include enriched data as well as aggregated data. For example, the configured rules and conditions can be based on aggregated data collected from multiple clients. In some embodiments, the rules are configured by requiring certain values for specific metrics, such as a certain application name or a certain location. As another example, a condition can require that the page load time exceed a certain threshold metric (such as a certain number of milliseconds) or that a response time exceed a certain threshold metric (such as a certain number of milliseconds). In some embodiments, a condition can require that a specified relationship (such as greater than, less than, or equal to) exists between aggregated metrics such as for the counts and/or volumes of certain metrics compared to threshold values before an issue is triggered. In some embodiments, a rule can be configured with a debounce to require, allow, or prevent repeated instances from triggering the detection of the corresponding issue.

At 509, the configured client is monitored. For example, the client configured for monitoring at 505 is monitored for issues configured at 507. In various embodiments, the installed monitoring agent, menu application, and browser monitoring extension each identify when monitoring should be performed, such as when a targeted application, hardware device, or other monitored target is active for monitoring. For example, the monitoring agent can monitor running processes on the client and when a process matches an application configured for application monitoring, metrics associated with the matching application are collected. Similarly, the browser monitoring extension can monitor active web sites accessed via the browser and when a web site matches a web application configured for monitoring, usage metrics associated with the matching web application are collected. In some embodiments, the metrics are collected and stored locally until they can be provided to the cloud-based issue resolution service. In some embodiments, the agent can also collect metrics and data as well as receive metrics collected by the menu application and/or browser monitoring extension.

At 511, one or more communication channels with the issue resolution service are activated. For example, one or more network connections are established between the client and the cloud-based issue resolution service. In some embodiments, a network connection is established with the installed monitoring agent running on the client. For example, the communication channel is established with the installed agent to provide the collected data stored at the agent to the cloud-based issue resolution service. The same communication channel can be later utilized to receive solutions for detected issues. In some embodiments, one or more communication channels with the issue resolution service are additionally activated between the issue resolution service and the menu application and/or the browser monitoring extension. For example, the menu application can connect directly to the issue resolution service to perform tasks such as to provide and/or receive updates. In some embodiments, the browser monitoring extension connects directly to the issue resolution service, for example, to provide collected browser application usage data directly to the cloud-based issue resolution service instead of via the installed agent.

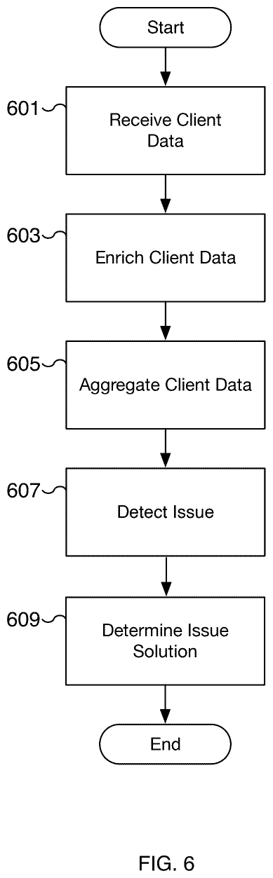

FIG. 6 is a flow chart illustrating an embodiment of a process for providing a solution to an issue detected from analyzing collected client data. For example, using the process of FIG. 6, a cloud-based issue resolution service receives and analyzes client data provided by clients to detect issues. Once an issue is detected, a solution for the issue is determined and provided to impacted clients. In various embodiments, the received client data is enriched and then further analyzed to provide an aggregated version of the data. In some embodiments, the received client data including the enriched and/or aggregated data is used to identify issues. In the event an existing known and validated solution for an identified issue does not exist, a solution can be generated dynamically. Once a dynamically generated solution is validated, the validated solution can be provided to impacted clients. In some embodiments, the process of FIG. 6 is performed by an issue resolution service at 403 and/or 405 of FIG. 4. In some embodiments, the issue resolution service is issue resolution service 111 of FIG. 1 and/or issue resolution service 301 of FIG. 3. In some embodiments, the client device providing the client data is client 101, 103, and/or 105 of FIG. 1 and/or client 201 of FIG. 2.

At 601, client data is received. For example, client data including usage data collected by a client is provided via an activated communication channel to the issue resolution service. The received data can include application usage data such as processor activity, processor performance, memory usage, storage usage, pending updates, application logs, application crash report data, network activity, and application runtime performance data as well as client device data associated with the device and in particular monitored applications. In some embodiments, the received client data includes a list of current running processes or the memory usage of one or more processes. In various embodiments, the client data is received as a stream of data and processed via a high throughput performance bus. In some embodiments, the data is received from multiple clients including by intermixing the different client data.

At 603, the client data is enriched. For example, the received client data is enriched with additional relevant data provided by sources other than the client. In some embodiments, the data is enriched based on a client and/or application identifier such as an IP address of the client. For example, based on a client's network address, a location can be determined for the client and the client data is enriched with location and/or geographic data, such as the client's city, region, state, and/or locale. Other data enrichment can include adding time stamps associated with collected data and calculating latency and throughput metrics for the client connection. Additional metadata not available at the client can be retrieved and/or determined and used to augment, annotate, and/or add additional detail to the collected client data. For example, a client identifier can be used to enrich the client's collected data with configuration data associated with the client device and/or users associated with the device. In some embodiments, the enriched data is based on information including aggregated information from multiple clients. For example, the usage data can be enriched based on collected data from across different clients of the same or different region.

At 605, the usage data is aggregated. For example, the raw client and/or enriched client data may be aggregated using data received from multiple clients and over multiple data updates. For example, for a particular application and/or application version, the received client data can be analyzed to provide aggregated results such as the average application uptime for an application, the average number of crashes for an application, the average page load time for the applications, and/or the typical usage time for an application, etc. In various embodiments, the data is aggregated over one or more different windows of time, such as per day, per week, per month, etc. In some embodiments, the data is aggregated based on geography such as by region, by sub-region, by network location, etc. For example, the data can be aggregated based on sub-region to identify patterns for a region. Other forms of aggregation can be performed as well, such as by user groups, usage metrics, departments, operating system version, application version, etc. In some embodiments, the aggregated data results include processing raw data as time-series data to produce rolled-up data results. For example, rolled-up usage data can be provided by merging usage data across multiple clients and trimming the merged data to emphasize the most relevant metrics.

At 607, issues are detected. For example, the enriched and/or aggregated data is analyzed to identify issues impacting clients. In some embodiments, the client data is analyzed as least in part by applying configured rules to detect issues. For example, rules can be configured that specify the conditions required to trigger a detected issue. The configured conditions can reference values associated with the client data including the enriched and/or aggregated versions of the collected data. For example, a condition triggering the detection of an issue can require that the page load time for clients accessing a web-based application from a certain geographic location exceeds a certain threshold. As another example, a condition triggering the detection of a different issue can require that the amount of memory allocated to a certain version of an application running a particular hardware and software configuration exceeds a certain threshold. In some embodiments, a configured condition can require that a specified relationship (such as greater than, less than, or equal to) exists between aggregated metrics such as for the counts and/or volumes of certain metrics compared to threshold values before an issue is triggered. In some embodiments, a rule can be configured with a debounce to require, allow, or prevent repeated instances from triggering the detection of the corresponding issue.

At 609, an issue solution is determined. For example, a solution is determined for the identified issue detected at 607. In various embodiments, the solution must be a validated solution, such as a solution validated to resolve the issue for the impacted client. A validated solution can be a description of the steps required to resolve an identified issue, such as which software applications require updating and the directions for how to perform the updates. In some embodiments, a validated solution is a software patch such as a packaged update that is provided to the client for execution to update the appropriate software and/or firmware of the client to resolve the identified issue. In some embodiments, the validated solution is presented as a video explanation, an audio explanation, an interactive or guided explanation, and/or via another format. For example, a chat bot can provide the solution to an identified issue by interactively walking a user through the steps to perform the solution while also confirming that each of the steps have been properly performed.

In various embodiments, a validated solution can be retrieved from a known solutions repository. For example, a repository can store known and validated solutions and the appropriate solution can be determined by retrieving the known and validated solution from the repository. In the event no known and validated solution exists, for example, in a known solutions repository, a solution can be generated dynamically using a generative machine learning model and/or generative artificial intelligence (AI) techniques. For example, a trained large language model can be utilized with a generated generative AI prompt to determine a solution for the identified issue. In some embodiments, the results from using generative AI techniques are first validated, for example, by an administrator (such as a human operator) and/or via an automated technique, before it is provided to the client. In various embodiments, once a dynamically generated solution is validated, it can be stored in a known solutions repository and used for future instances of the issue without requiring the solution be regenerated.

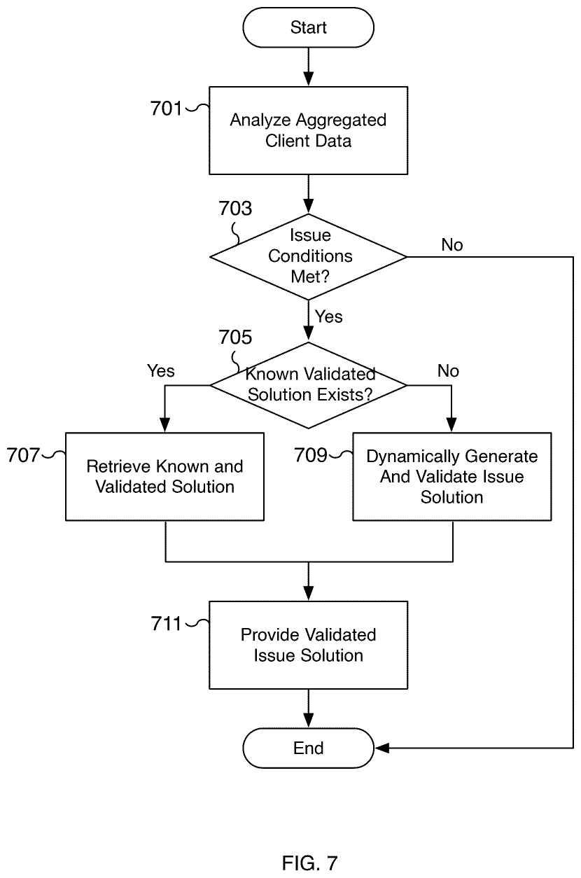

FIG. 7 is a flow chart illustrating an embodiment of a process for providing a validated solution to an issue detected from analyzing collected client data. For example, using the process of FIG. 7, a cloud-based issue resolution service analyzes aggregated client data provided by clients to detect issues. Once an issue is detected, a validated solution for the issue is determined and provided to impacted clients. In the event an existing known and validated solution for an identified issue does not exist, a solution can be generated dynamically and then validated and provided to impacted clients. In some embodiments, the process of FIG. 7 is performed by an issue resolution service at 405 and/or 407 of FIG. 4 and/or at 607 and/or 609 of FIG. 6. In some embodiments, the issue resolution service is issue resolution service 111 of FIG. 1 and/or issue resolution service 301 of FIG. 3. In some embodiments, the client device providing the client data is client 101, 103, and/or 105 of FIG. 1 and/or client 201 of FIG. 2. In some embodiments, the process of FIG. 7 is performed at least in part by an issue identification module such as issue identification module 319 of FIG. 3.

At 701, aggregated client data is analyzed. For example, data aggregated from multiple clients including enriched client data is analyzed for issues that will impact a client. The analysis can include evaluating one or more rules that specify conditions required for detecting an issue. The configured conditions can reference values associated with the aggregated client data. For example, a configured condition can require that a specified relationship (such as greater than, less than, or equal to) exists between aggregated metrics such as for the counts and/or volumes of certain metrics (such as page load time and response time) compared to threshold values before an issue is triggered.

At 703, a determination is made whether issue conditions are met. In the event issue conditions are met, processing proceeds to 705 in response to a detected issue. In the event issue conditions are not met, processing completes. For example, in the event issue conditions are not met, analysis for issues based on the current data is complete. Processing for issues based on new data can continue by repeating the process of FIG. 7, for example, when a client's conditions change such as when additional data is received.

At 705, a determination is made whether a known validated solution exists. In the event a known and validated solution exists, processing proceeds to 707. In the event a known and validated solution does not exist, processing proceeds to 709.

At 707, a known and validated solution is retrieved. For example, a determination is made that a known and validated solution exists for the identified issue and the known and validated solution is retrieved from a known solutions repository. In various embodiments, the repository can be indexed by issue, issue properties, issue characteristics, client configuration, and/or another index type and/or set of indices. In some embodiments, two or more known solutions repositories can exist and the known repositories can include distributed and external repositories. In the event multiple known and validated solutions exist for the identified issue, the solutions can be ranked and the best solution can be provided. In some embodiments, multiple solutions may be provided, if appropriate. For example, multiple different solutions can be provided based on the desired outcome such as one that prioritizes performance and another one that prioritizes available features.

At 709, an issue solution is dynamically generated and validated. For example, in the event no known and validated solution exists, at 709, a new solution is dynamically generated and validated. In various embodiments, the new solution is generated dynamically using a generative machine learning model and/or generative artificial intelligence (AI) techniques. For example, a trained large language model can be utilized with a generated generative AI prompt to determine a solution for the identified issue. In various embodiments, the trained large language model can be a locally hosted and supported generative AI model or one provided by a third-party and/or hosted remotely. The models, whether hosted locally, remotely, and/or via a third-party can be accessed and inference performed as via a generative AI model application programming interface (API). In some embodiments, the solution generation process is an iterative process that allows a user to interact with a provided proposed solution and continuously improve the solution by modifying the generative AI context with additional information including refinement prompts. Once a solution is generated, the solution is validated. In various embodiments, a solution can be validated by an administrator (such as a human operator) and/or via automated techniques such as by evaluating the effectiveness of the solution based on collected metrics after the solution is applied (such as in a test environment and/or on a set of test clients), evaluating a solution compared to other existing and validated solutions, receiving third-party validation such as from an application or hardware vendor, and/or using another appropriate automated technique. In some embodiments, once a dynamically generated solution is validated, it can be stored in a known solutions repository and used for future instances of the issue without requiring the solution be regenerated.

At 711, a validated issue solution is provided. For example, a validated solution can be provided at 711 to impacted clients. In various embodiments, the validated solution can be provided to a monitoring agent of the client and accessed by a user of the client via a menu application and/or browser of the client. For example, a menu application (of a browser application via a browser extension) of the client can function as a graphical user interface for reviewing and managing the issue and applying the provided solution for the identified issue.

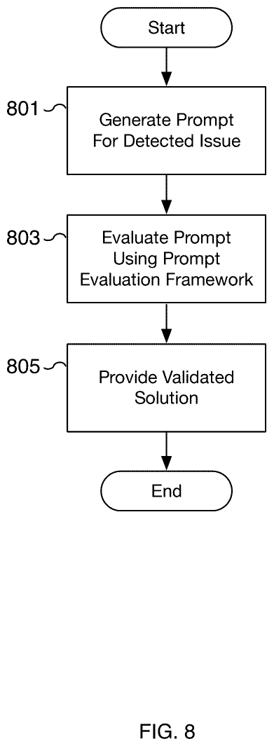

FIG. 8 is a flow chart illustrating an embodiment of a process for generating dynamically an issue solution. For example, using the process of FIG. 8, a solution for an issue can be generated by evaluating a generative artificial intelligence (AI) prompt with a generative machine learning model such as a large language model. In some embodiments, the process of FIG. 8 is performed by an issue resolution service at 405 and/or 407 of FIG. 4 and/or at 607 and/or 609 of FIG. 6. In some embodiments, the issue resolution service is issue resolution service 111 of FIG. 1 and/or issue resolution service 301 of FIG. 3. In some embodiments, the client device providing the client data is client 101, 103, and/or 105 of FIG. 1 and/or client 201 of FIG. 2. In some embodiments, the process of FIG. 8 is performed by a prompt evaluation framework such as prompt evaluation framework 321 of FIG. 3 using a generative AI model such as a model of trained large language models 323 of FIG. 3.

At 801, a generative artificial intelligence (AI) prompt is generated for a detected issue. For example, a generative AI prompt for a trained large language model is created to request for a solution for an identified issue. The prompt can be created using a prompt template and the created prompt can include context of the detected issue. For example, the included context data can include client monitored metrics such as example or actual crash data and/or application logs, performance metrics, error codes, error descriptions, and/or configuration settings, etc. In some embodiments, the included context can further include aggregated data and/or enriched client data. Other information included in the generated prompt can include client properties such as the client software and/or hardware configuration, the client location, and/or the client deployment configuration, among other information. In various embodiments, example issues and solutions are also provided in the prompt context, such as examples that describe the desired output format for a requested solution.

At 803, the generated prompt is evaluated using a prompt evaluation framework. For example, the prompt generated at 801 is evaluated using a framework that applies the prompt to a generative artificial intelligence (AI) model such as a trained large language model. The generated AI prompt requests a dynamically generated solution for the identified issue in part by providing the appropriate context for the trained large language model to create a solution for an impacted client. In some embodiments, the evaluation framework provides the prompts as a sequence of prompts such as an initial system prompt followed by one or more additional prompts to refine the generated solution. In some embodiments, a human operator can iteratively update the prompt and/or context to iteratively refine the solution provided by the trained generative AI model. In various embodiments, when applying the prompt to a selected model, the prompt evaluation framework can access external data sources such as solution databases provided and supported by third parties such as vendors and manufacturers. As another example, the prompt evaluation framework may be configured to access the Internet including discussion forums for resolving information technology errors. Using the prompt evaluation framework, the solution can be generated using a selected model and supplemented and/or refined with data sourced from these external data sources. Although described with respect to applying a single generative AI model, in particular embodiments, multiple models may be utilized to achieve the desired solution for the identified issue.

At 805, a validated solution is provided. For example, the solution dynamically generated at 803 is validated and provided as a solution result. In various embodiments, a solution can be validated by an administrator (such as a human operator) and/or via automated techniques such as by evaluating the effectiveness of the solution based on collected metrics after the solution is applied (such as in a test environment and/or on a set of test clients), evaluating a solution compared to other existing and validated solutions, receiving third-party validation such as from an application or hardware vendor, and/or using another appropriate automated technique. Once the dynamically generated solution is validated, the resulting solution is provided as a known and validated solution. In some embodiments, the validated solution is further stored in a known solutions repository and available for retrieval for future instances of the issue without requiring the solution be regenerated dynamically.

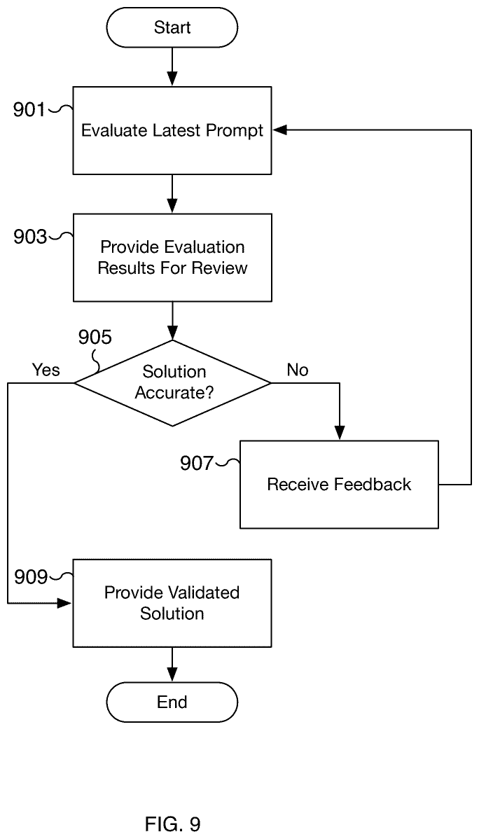

FIG. 9 is a flow chart illustrating an embodiment of a process for generating dynamically an issue solution using received feedback. For example, using the process of FIG. 9, an issue resolution service applies an iterative process to refine a dynamically generated solution for an information technology issue based on received feedback. By repeatedly refining the context provided to a generative artificial intelligence (AI) model, a more precise and accurate solution can be generated. In some embodiments, the process of FIG. 9 is performed by an issue resolution service at 405 and/or 407 of FIG. 4, at 607 and/or 609 of FIGS. 6, and/or 801, 803, and/or 805 of FIG. 8. In some embodiments, the issue resolution service is issue resolution service 111 of FIG. 1 and/or issue resolution service 301 of FIG. 3. In some embodiments, the client device providing the client data is client 101, 103, and/or 105 of FIG. 1 and/or client 201 of FIG. 2. In some embodiments, the process of FIG. 9 is performed by a prompt evaluation framework such as prompt evaluation framework 321 of FIG. 3 using a generative AI model such as a model of trained large language models 323 of FIG. 3.

At 901, the latest prompt is evaluated. For example, a prompt is generated and/or updated and then evaluated by applying the new prompt to a selected generative AI model. If an existing evaluation context exists, the latest prompt updates the context provided to the model using feedback received at 907. For example, the received feedback can be used to generate the latest prompt that is evaluated using the selected model to refine the solution result. In some embodiments, the latest prompt is one of a sequence of related prompts that are each applied to refine the solution generation process. In some embodiments, the prompt is applied to the appropriate trained model via a prompt evaluation framework such as prompt evaluation framework 321 of FIG. 3.

At 903, evaluation results are provided for review. For example, the evaluation results provided by the generative AI model in response to the provided prompt (or prompt sequence) are provided for review. In some embodiments, the review can be performed by a human operator such as by an administrator. The provided solution can be displayed, such as via a user interface, as a number of steps to apply at the client to resolve the relevant issue. In some embodiments, the review is performed at least partially by an automated system. For example, the provided solution can be executed by applying the solution steps to a client such as a test client created to mimic an impacted client. By applying the determined solution to a test client, the solution can be automatically evaluated to determine its effectiveness, such as by monitoring an updated test client to determine if the identified issue still exists and/or has been resolved. In various embodiments, a solution that is reviewed and determined as accurate is approved and considered validated.

At 905, a determination is made whether the solution is accurate. For example, a determination is made whether the solution is sufficiently accurate including whether the solution has been approved and validated. In the event the solution is determined to be accurate, processing proceeds to 909 where a validated solution is provided as a solution result. In the event the solution is determined to not meet accuracy requirements, processing proceeds to 907 where feedback can be received to improve the accuracy of the solution. In various embodiments, a solution that does not meet accuracy requirements may include unnecessary steps, may include steps that require additional clarification, may include steps that are ineffective or duplicative, and/or may require additional missing steps, among other deficiencies.

At 907, feedback is received. For example, when a generated solution is insufficiently accurate, feedback is received to improve the solution. The feedback can describe and/or identify additional requirements and/or deficiencies related to the generated solution. In some embodiments, the received feedback can be provided via natural language such as via a chat or similar interface configured to accept user provided feedback. For example, a user can require, as expressed using a natural language format, that an included step of the solution requires additional explanation. In some embodiments, the included feedback is automatically generated feedback such as collected metrics and/or usage results from a test client on which the generated solution has been applied. For example, application logs, crash reports, operating metrics, and/or other test client data can be included in the feedback received. In various embodiments, the received feedback is used to automatically generate a follow-up prompt and/or updated context that can be applied to improve the accuracy of the solution. The generated prompt can include/incorporate past prompts and/or previously received feedback. In some embodiments, an updated prompt can be generated with the intent to apply the prompt in the same/existing context as previously applied prompts.

At 909, a validated solution is provided. For example, an approved and validated solution is provided as a solution result. In various embodiments, the validated solution has been refined though one or more iterations of updating the prompt and/or the prompt context. In some embodiments, the validated solution is further stored in a known solutions repository and available for retrieval for future instances of the issue without requiring the solution be regenerated dynamically.

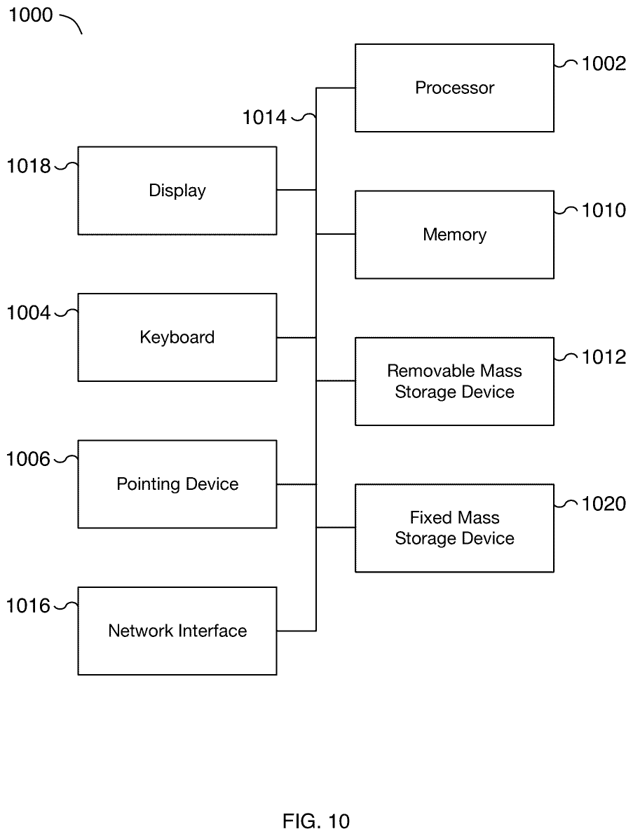

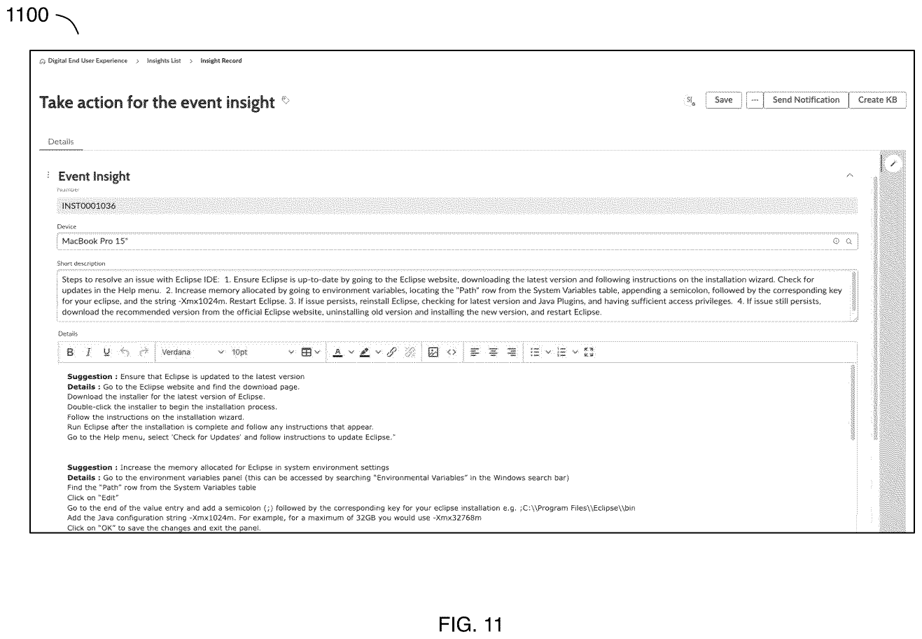

FIG. 10 is a functional diagram illustrating a programmed computer system for resolving issues impacting clients. As will be apparent, other computer system architectures and configurations can be utilized for resolving issues impacting clients including those with one or more graphical processing units (GPUs). Examples of computer system 1000 include clients 101, 103, and 105 of FIG. 1, client 201 of FIG. 2, one or more computers of issue resolution service 111 of FIG. 1, and/or one or more computers of issue resolution service 301 of FIG. 3. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018). In various embodiments, one or more instances of computer system 1000 can be used to implement at least portions of the processes of FIGS. 4-9 and the user interfaces of FIGS. 11-13.

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data and objects used by the processor 1002 to perform its functions (e.g., programmed instructions). For example, memory 1010 can include any suitable computer-readable storage media, described below, depending on whether, for example, data access needs to be bi-directional or unidirectional. For example, processor 1002 can also directly and very rapidly retrieve and store frequently needed data in a cache memory (not shown).

A removable mass storage device 1012 provides additional data storage capacity for the computer system 1000, and is coupled either bi-directionally (read/write) or unidirectionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storages 1012, 1020 generally store additional programming instructions, data, and the like that typically are not in active use by the processor 1002. It will be appreciated that the information retained within mass storages 1012 and 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

FIG. 11 is a diagram illustrating an embodiment of a user interface for viewing a validated solution for an identified issue. In the example shown, user interface 1100 is a user interface view of a validated solution provided by an issue resolution service. User interface 1100 includes and displays an issue identifier (“INST0001036”), a device impacted by the issue (“MacBook Pro 15″”), a short description of the solution, and a detailed description of the solution. User interface 1100 is presented to an information technology administrator of the impacted client, such as the system administrator managing a group of clients that includes the impacted client. As shown in FIG. 11, user interface 1100 allows the administrator to send a notification to the impacted client. In various embodiments, a version of the solution shown in FIG. 11 is provided to an impacted client when the issue is detected. The provided solution can be accessed by users of the impacted client, for example, via a menu application installed on the client. In some embodiments, the menu application is menu application 211 of FIG. 2. In some embodiments, the solution is accessed via a browser of the impacted client and/or via another appropriate user interface accessible from the impacted client. In some embodiments, user interface 1100 is provided by an issue resolution service such as issue resolution service 111 of FIG. 1 and/or issue resolution service 301 of FIG. 3. In some embodiments, data used to identify the issue that can be resolved using the solution shown in user interface 1100 is collected from clients such as client 101, 103, and/or 105 of FIG. 1 and/or client 201 of FIG. 2 using the processes of FIGS. 4-9.

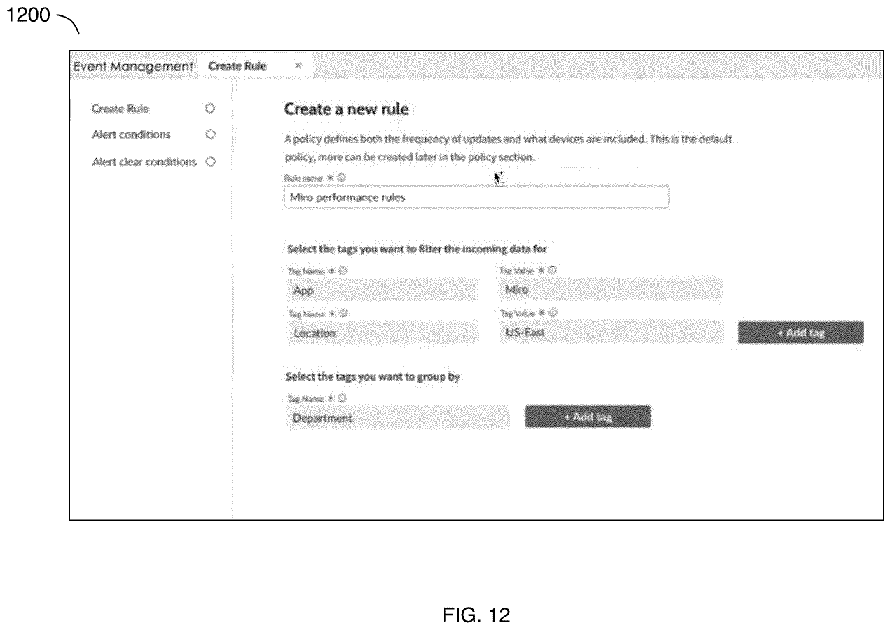

FIG. 12 is a diagram illustrating an embodiment of a user interface for creating a rule for automatically identifying an issue impacting a monitored client. In the example shown, user interface 1200 is a user interface view provided by an issue resolution service for creating a new rule. User interface 1200 includes fields for naming the rule and for assigning values to tags for the rule. For example, the “Location” tag is assigned the value “US-East.” In various embodiments, user interface 1200 is one of a sequence of screens used by an administrator to create a rule that when the defined condition(s) of the rule are met, triggers the identification of an issue for an impacted client. In some embodiments, user interface 1200 is utilized at step 507 of FIG. 5 as part of the process for configuring a condition for detecting an issue. In some embodiments, user interface 1200 is provided by an issue resolution service such as issue resolution service 111 of FIG. 1 and/or issue resolution service 301 of FIG. 3. In some embodiments, a rule configured using user interface 1200 is applied to data collected from clients such as client 101, 103, and/or 105 of FIG. 1 and/or client 201 of FIG. 2 using the processes of FIGS. 4-9.

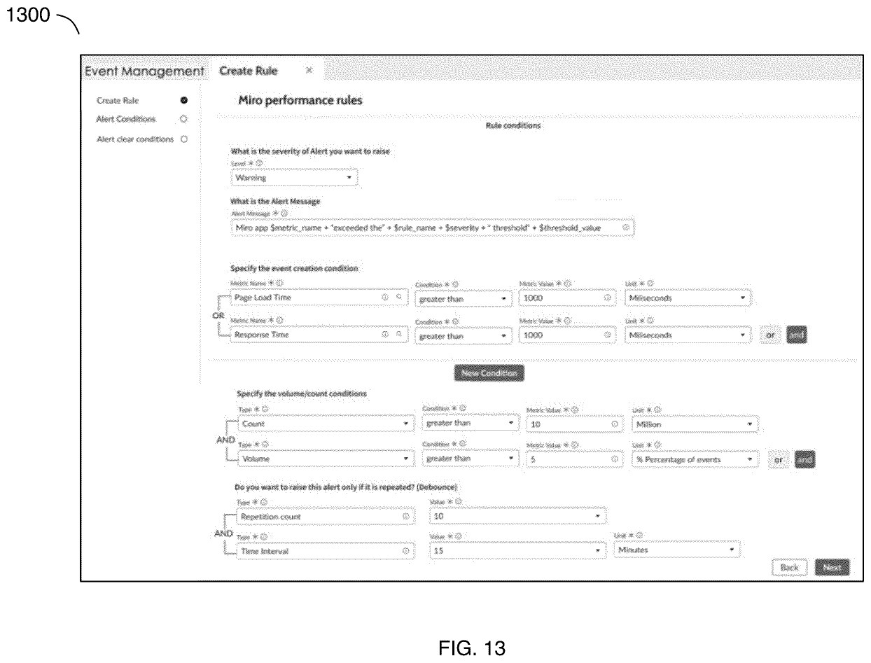

FIG. 13 is a diagram illustrating an embodiment of a user interface for defining conditions for a rule for automatically identifying an issue impacting a monitored client. In the example shown, user interface 1300 is a user interface view provided by an issue resolution service for defining rule conditions. User interface 1300 includes fields specifying the severity of the alert to raise when the specified conditions are met and fields for specifying the conditions. The specified condition can be based on monitored client data including values based on aggregated client data. In various embodiments, user interface 1300 is one of a sequence of screens used by an administrator to create a rule that when the defined condition(s) of the rule are met, triggers the identification of an issue for an impacted client. In some embodiments, user interface 1300 is utilized at step 507 of FIG. 5 along with user interface 1200 of FIG. 12 as part of the process for configuring a condition for detecting an issue. In some embodiments, user interface 1300 is provided by an issue resolution service such as issue resolution service 111 of FIG. 1 and/or issue resolution service 301 of FIG. 3. In some embodiments, a rule configured using user interface 1300 is applied to data collected from clients such as client 101, 103, and/or 105 of FIG. 1 and/or client 201 of FIG. 2 using the processes of FIGS. 4-9.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving a specification of a condition to trigger detection of a specific issue of an information technology component;
collecting computer usage data via one or more computer agents on one or more clients;
identifying a portion of the computer usage data that satisfies the condition of the specific issue;
determining a prompt based on the portion of the computer usage data; and
generating, using a generative machine learning model, a solution to the specific issue based on the prompt.

2. The method of claim 1, further comprising receiving an indication that the solution to the specific issue characterized by the condition is to be generated dynamically using the generative machine learning model.

3. The method of claim 1, wherein the condition to trigger the detection of the specific issue is associated with a specific geographic region or a specific application name.

4. The method of claim 1, wherein the collected computer usage data includes at least one of the following: a response time, a session time, a page load time, or a last access time.

5. The method of claim 1, wherein the collected computer usage data includes at least one of the following: processor activity data, processor performance data, memory usage data, storage usage data, pending update data, application log data, application crash report data, or network activity data.

6. The method of claim 1, wherein the collected computer usage data includes a list of current running processes or a memory usage of one or more processes.

7. The method of claim 1, wherein the specific issue of the information technology component is associated with an application.

8. The method of claim 7, wherein the application is a web-based application.

9. The method of claim 1, wherein the generative machine learning model is accessed via an application programming interface.

10. The method of claim 1, further comprising storing the solution to the specific issue in a known solutions repository.

11. A system comprising:
one or more processors; and
a memory coupled to the one or more processors, wherein the memory is configured to provide the one or more processors with instructions which when executed cause the one or more processors to:
receive a specification of a condition to trigger detection of a specific issue of an information technology component;
collect computer usage data via one or more computer agents on one or more clients;
identify a portion of the computer usage data that satisfies the condition of the specific issue;
determine a prompt based on the portion of the computer usage data; and
generate, using a generative machine learning model, a solution to the specific issue based on the prompt.

12. The system of claim 11, wherein the memory is further configured to provide the one or more processors with instructions which when executed cause the one or more processors to receive an indication that the solution to the specific issue characterized by the condition is to be generated dynamically using the generative machine learning model.

13. The system of claim 11, wherein the condition to trigger the detection of the specific issue is associated with a specific geographic region or a specific application name.

14. The system of claim 11, wherein the collected computer usage data includes at least one of the following: a response time, a session time, a page load time, or a last access time.

15. The system of claim 11, wherein the collected computer usage data includes at least one of the following: processor activity data, processor performance data, memory usage data, storage usage data, pending update data, application log data, application crash report data, or network activity data.

16. The system of claim 11, wherein the collected computer usage data includes a list of current running processes or a memory usage of one or more processes.

17. The system of claim 11, wherein the specific issue of the information technology component is associated with an application.

18. The system of claim 11, wherein the generative machine learning model is accessed via an application programming interface.

19. The system of claim 11, wherein the memory is further configured to provide the one or more processors with instructions which when executed cause the one or more processors to store the solution to the specific issue in a known solutions repository.

20. A computer program product, the computer program product being embodied in a non-transitory computer readable storage medium and comprising computer instructions for:
receiving a specification of a condition to trigger detection of a specific issue of an information technology component;
collecting computer usage data via one or more computer agents on one or more clients;
identifying a portion of the computer usage data that satisfies the condition of the specific issue;
determining a prompt based on the portion of the computer usage data; and
generating, using a generative machine learning model, a solution to the specific issue based on the prompt.
